(19) United States
(12) Patent Application Publication
(10) Pub. No.: US 2009/0117848 A1
(43) Pub. Date: May 7, 2009

(54) Mobile device system and mobile device

(76) Inventors: Hideki Nagata, Hachioji-shi (JP); Hiroyuki Minakata, Hachioji-shi (JP); Takayuki Ide, Fussa-shi (JP); Atsushi Kohashi, Akiruno-shi (JP); Minoru Omaki, Kunitachi-shi (JP)

Correspondence Address: KENYON & KENYON LLP, ONE BROADWAY, NEW YORK, NY, 10004, US

(21) Appl. No.: 11/903,226

(22) Filed: Sep. 20, 2007

(30) Foreign Application Priority Data
Sep. 28, 2006 (JP) 2006-264747

(51) Int. Cl. H04B 7/00

(52) U.S. Cl. 455/41.2; 340/539.32; 455/456.1

(57) ABSTRACT

Even when the mobile devices which one carries change from day to day, the invention can flexibly handle such changes to prevent misplacement and the like of a mobile device. Each mobile device includes a communication unit for communicating with other mobile devices, a GPS receiver for acquiring current location information of the mobile device, a group registration unit, an announcing unit, and a control unit. In each mobile device, other mobile devices located within a predetermined range of that mobile device are registered as a group in the group registration unit, and after this registration, the other mobile devices located within the predetermined range of the mobile device are periodically detected, and when the combination of detected other mobile devices does not match the combination of other mobile devices registered in the group registration unit, the announcing unit is operated.

### BACKGROUND OF THE INVENTION

1. Field of the Invention

The present invention relates to a mobile device system and a mobile device which can quickly notify misplacement or the like of a mobile device.

This application is based on Japanese Patent Application No. 2006-264747, the content of which is incorporated herein by reference.

2. Description of Related Art

Recently, due to the diversification of information, when people go out, in many cases they carry multiple mobile devices having various functions, such as mobile phones, laptop computers, information communication terminals, digital cameras, and music players (see Japanese Unexamined Patent Application, Publication No. 2002-9879).

Along with this trend, a technology for preventing users from forgetting to take their mobile device when going out and misplacing a mobile device outside the home has been proposed (see Japanese Unexamined Patent Application, Publication No. 2006-60544).

For example, Japanese Unexamined Patent Application, Publication No. 2006-60544 discloses a technology for periodically sending and receiving location information between a wireless key and a communication phone terminal, determining the distance therebetween on the basis of the information, and providing a misplacement alert or the like when the determined distance becomes longer than a predetermined value.

### BRIEF SUMMARY OF THE INVENTION

A first aspect of the present invention is a mobile device system including a plurality of mobile devices, to each of which unique identification information is assigned; wherein each mobile device includes a communication unit configured to communicate with other mobile devices, a location-information acquisition unit configured to acquire current location information of that mobile device, a group registration unit, an announcing unit, and a control unit; wherein, in each mobile device, the control unit links the location information acquired by the location-information acquisition unit with the identification information of that mobile device, sends the information to the other mobile devices using the communication unit, detects the other mobile devices located within a predetermined range of the mobile device on the basis of location information received from the other mobile devices by the communication unit and the location information of the mobile device, and registers the identification information of the detected other mobile devices as a group in the group registration unit, and after registering the group, by periodically operating the communication unit, periodically detects the other mobile devices located within the predetermined range of the mobile device and operates the announcing unit when a group status of the detected other mobile devices differs from a group status registered in the group registration unit.

A second aspect of the present invention is a mobile device system including a plurality of mobile devices, to each of which unique identification information is assigned; wherein each mobile device includes a communication unit configured to communicate with other mobile devices located in the vicinity, a group registration unit, an announcing unit, and a control unit; wherein, in each mobile device, the control unit detects other mobile devices located in the vicinity of that mobile device on the basis of whether or not the identification information is received from the other mobile devices by the communication unit and registers the identification information of the detected other mobile devices as a group in the group registration unit, and after registering the group, by periodically operating the communication unit, periodically detects the other mobile devices located in the vicinity of the mobile device and operates the announcing unit when a group status of the detected other mobile devices differs from a group status registered in the group registration unit.

A third aspect of the present invention is a mobile device including a communication unit configured to communicate with other mobile devices; a location-information acquisition unit configured to acquire current location information of that mobile device; a group registration unit; an announcing unit; and a control unit, wherein the control unit links the location information acquired by the location-information acquisition unit with the identification information of that mobile device, sends the information to the other mobile devices using the communication unit, detects the other mobile devices located within a predetermined range of the mobile device on the basis of the location information received from the other mobile devices by the communication unit and the location information of the mobile device, and registers the identification information of the detected other mobile devices as a group in the group registration unit, and after registering the group, by periodically operating the communication unit, periodically detects the other mobile devices located within the predetermined range of the mobile device and operates the announcing unit when a group status of the detected other mobile devices differs from a group status registered in the group registration unit.

A fourth aspect of the present invention is a mobile device comprising a communication unit configured to communicate with other mobile devices located in the vicinity thereof; a group registration unit; an announcing unit; and a control unit, wherein the control unit sends identification information assigned to that mobile device using the communication unit, detects other mobile devices located in the vicinity of that mobile device on the basis of whether or not the identification information is received from the other mobile devices by the communication unit, and registers the identification information of the detected other mobile devices as a group in the group registration unit, and after registering the group, by periodically operating the communication unit, periodically detects the other mobile devices located in the vicinity of the mobile device and operates the announcing unit when a group status of the detected other mobile devices differs from a group status registered in the group registration unit.

### BRIEF DESCRIPTION OF THE SEVERAL VIEWS OF THE DRAWINGS

FIG. 1 is a diagram showing the configuration of a mobile device system according to a first embodiment.

FIG. 2 is a diagram showing common components provided in each mobile device of the mobile device system according to the first embodiment.

FIG. 3 is a diagram showing an example of information stored in a storage unit of a mobile phone according to the first embodiment.

FIG. 4 is a flowchart showing the procedure of a misplacement detection process executed by a control unit according to the first embodiment.

FIG. 5 is a diagram showing a display example in a case where a PDA and a computer are located in the vicinity of the mobile phone.

FIG. 6 is a diagram showing common components provided in each mobile device of a mobile device system according to a second embodiment.

FIG. 7 is a diagram showing an example of information stored in the storage unit of the mobile phone according to the second embodiment.

FIG. 8 is a flowchart showing the procedure for a misplacement detection process according to the second embodiment.

### DETAILED DESCRIPTION OF THE INVENTION

A mobile device system of the present invention includes a plurality of mobile devices, to each of which unique identification information is assigned; wherein each mobile device includes a communication unit configured to communicate with other mobile devices, a location-information acquisition unit configured to acquire current location information of that mobile device, a group registration unit, an announcing unit, and a control unit; wherein, in each mobile device, the control unit links the location information acquired by the location-information acquisition unit with the identification information of that mobile device, sends the information to the other mobile devices using the communication unit, detects the other mobile devices located within a predetermined range of the mobile device on the basis of location information received from the other mobile devices by the communication unit and the location information of the mobile device, and registers the identification information of the detected other mobile devices as a group in the group registration unit, and after registering the group, by periodically operating the communication unit, periodically detects the other mobile devices located within the predetermined range of the mobile device and operates the announcing unit when a group status of the detected other mobile devices differs from a group status registered in the group registration unit.

According to this configuration, the location information acquired by the location-information acquisition unit in each mobile device is linked to the identification information of each mobile device and is sent to the other mobile devices by the communication unit. Thus, the location information of each mobile device is mutually sent and received between each mobile device. In each mobile device, the other mobile devices within a predetermined range of that mobile device are detected on the basis of the location information received from the other mobile devices by operating the communication unit and the location information of that mobile device, and the identification information of the detected mobile devices is registered as a group in the group registration unit. Accordingly, even if the combination of mobile devices which the user carries together changes from day to day, the system can flexibly respond in those situations and can register, as a group, the identification information of the mobile devices which are carried together.

Then, after the registration described above, by periodically sending and receiving location information between each mobile device, in each mobile device, other mobile devices that are within the predetermined range of that mobile device are periodically detected. In this case, when the group status of the other mobile devices detected as being within the predetermined range of that mobile device does not match the group status registered in the group registration unit due to misplacement by the user etc., the announcing unit in each mobile device is operated, and therefore, the user can quickly notice that he or she has misplaced a mobile device based on this announcement.

Another mobile device system of the present invention includes a plurality of mobile devices, to each of which unique identification information is assigned; wherein each mobile device includes a communication unit configured to communicate with other mobile devices located in the vicinity, a group registration unit, an announcing unit, and a control unit; wherein, in each mobile device, the control unit detects other mobile devices located in the vicinity of that mobile device on the basis of whether or not the identification information is received from the other mobile devices by the communication unit and registers the identification information of the detected other mobile devices as a group in the group registration unit, and after registering the group, by periodically operating the communication unit, periodically detects the other mobile devices located in the vicinity of the mobile device and operates the announcing unit when a group status of the detected other mobile devices differs from a group status registered in the group registration unit.

According to this configuration, the identification information uniquely assigned to each mobile device is sent to all of the other mobile devices located within the communication range by operating the communication unit. Thus, the identification information of each mobile device is mutually sent and received between each mobile device located in the vicinity. In each mobile device, other mobile devices located in the vicinity of that mobile device are detected on the basis of whether or not the identification information is received from the other mobile devices by the communication unit, and the detected other mobile devices are registered as a group in the group registration unit. Accordingly, even when the combination of mobile devices that the user carries varies from day to day, the system can flexibly respond in those situations and can register, as a group, the identification information of the mobile devices that are carried together.

Then, after registration, by periodically sending and receiving the identification information of each mobile device, the other mobile devices located in the vicinity of that mobile device are periodically detected. In this case, when the group status of the other mobile devices detected as being located in the vicinity of that mobile device does not match the group status registered in the group registration unit due to misplacement by the user etc., the announcing unit in each mobile device is operated, and therefore, the user can quickly notice that he or she has misplaced a mobile device based on that announcement.

The communication unit may use wireless or wired communication. When using wireless communication, for example, a communication method such as Bluetooth, infrared communication, human-body communication, or near field communication (NFC) may be employed. When using wired communication, for example, a communication method using contact terminals may be employed.

In the mobile device system described above, a communication range of the communication unit may be set to a range allowing the user to confirm that the mobile devices are being carried together.

According to this configuration, it can be confirmed that the other mobile devices identified by the identification information received by the communication unit are carried together with a particular mobile device by the user. The communication range is, for example, from about 1 m to 10 m.

In the mobile device system described above, the communication unit is, for example, a short-range communication unit.

With this configuration, since the short-range communication unit is used as the communication unit, it can be confirmed that the other mobile devices which are identified by the identification information received by the communication unit are carried together with a particular device by the user. An example of the short-range communication unit is a Blue Tooth device or the like.

In the mobile device system described above, the control unit in each mobile device may operate the announcing unit when a combination of the identification information of the detected other mobile devices differs from a combination of the identification information registered as a group in the group registration unit, or when a number of items of the identification information of the detected other mobile devices differs from a number of items of the identification information registered as a group in the group registration unit.

According to this configuration, when other mobile devices which were, until now, within the predetermined range go outside the predetermined range due to misplacement etc., the combination or number of other mobile devices detected as being located within the predetermined range of a particular mobile device does not match the combination or number of items of identification information registered as a group in the group registration unit. Therefore, by periodically monitoring the combination or number of items in the group, it is possible to readily detect misplacement of a mobile device.

In the mobile device system described above, owner information may be assigned to each mobile device, and the control unit in each mobile device may link the identification information of that mobile device with the owner information of that mobile device and send the information using the communication unit, and when the identification information and the owner information are received from the other mobile devices by the communication unit, the control unit may determine whether or not the received owner information matches the owner information of the mobile device and, when there is no match, may operate the announcing unit.

According to this configuration, owner information is also mutually sent and received between mobile devices. In this case, when the user mistakenly takes someone else's mobile device, the owner information of the other mobile devices received by the communication unit does not match the owner information of that device, and that fact is reported by the announcing unit. Therefore, the user can quickly notice that he or she has taken someone else's mobile device based on this announcement.

In the mobile device system described above, when operating the announcing unit, each mobile device may query whether the group registered in the group registration unit is to be updated.

According to this configuration, when notification of misplacement etc. of a mobile device is made by the announcing unit, the user is queried as to whether the group registered in the group registration unit is to be updated to the group of mobile devices being carried at that time. Therefore, the user can decide by himself whether to update the registration. Thus, when, for example, the user decides to change the mobile devices being carried, the combination of mobile devices after the change is registered as a new group in the group registration unit, and therefore, it is possible to remove the burden of performing announcing, with the announcing unit, again.

A mobile device of the present invention includes a communication unit configured to communicate with other mobile devices; a location-information acquisition unit configured to acquire current location information of that mobile device; a group registration unit; an announcing unit; and a control unit, wherein the control unit links the location information acquired by the location-information acquisition unit with the identification information of that mobile device, sends the information to the other mobile devices using the communication unit, detects the other mobile devices located within a predetermined range of the mobile device on the basis of the location information received from the other mobile devices by the communication unit and the location information of the mobile device, and registers the identification information of the detected other mobile devices as a group in the group registration unit, and after registering the group, by periodically operating the communication unit, periodically detects the other mobile devices located within the predetermined range of the mobile device and operates the announcing unit when a group status of the detected other mobile devices differs from a group status registered in the group registration unit.

According to this configuration, the location information acquired by the location-information acquisition unit is linked to the identification information of a particular mobile device and is sent to the other mobile devices by the communication unit. Thus, the location information of that mobile device can be reported to the other mobile devices. In addition, when location information of the other mobile devices is received by the communication unit, the other mobile devices located within a predetermined range of that mobile device are detected on the basis of this location information and the location information of that device, and the identification information of the detected mobile devices is registered as a group in the group registration unit. Accordingly, even when the combination of mobile devices which the user carries varies from day to day, the system can flexibly respond in those situations and can register, as a group, information about the mobile devices being carried together.

Then, after the registration described above, by periodically sending and receiving location information between the other mobile devices, the other mobile devices within the predetermined range of that mobile device are periodically detected. In this case, when the group status of the other mobile devices detected as being within the predetermined range of that mobile device does not match the group status registered in the group registration unit due to misplacement by the user etc., the announcing unit is operated, and therefore, the user can quickly notice that he or she has misplaced a mobile device based on this announcement.

Another mobile device of the present invention includes a communication unit configured to communicate with other mobile devices located in the vicinity thereof; a group registration unit; an announcing unit; and a control unit, wherein the control unit sends identification information assigned to that mobile device using the communication unit, detects other mobile devices located in the vicinity of that mobile device on the basis of whether or not the identification information is received from the other mobile devices by the communication unit, and registers the identification information of the detected other mobile devices as a group in the group registration unit, and after registering the group, by periodically operating the communication unit, periodically detects the other mobile devices located in the vicinity of the mobile device and operates the announcing unit when a group status of the detected other mobile devices differs from a group status registered in the group registration unit.

According to this configuration, the identification information uniquely assigned to the mobile device is sent to other mobile devices by the communication unit. Thus, the identification information of that mobile device can be reported to the other mobile devices located within the communication range of the communication unit. Also, the other mobile devices located in the vicinity of that device are detected based on whether or not the identification information of the other mobile devices is received by the communication unit, and information about the detected other mobile devices is registered in the group registration unit. Accordingly, even when the combination of mobile devices which the user carries varies from day to day, the system can flexibly respond in those situations and can register, as a group, the information about the mobile devices being carried together.

Then, after the registration, the identification information of all mobile devices located within the communication range of the communication unit is periodically received, and therefore, the other mobile devices in the vicinity of that mobile device can be periodically detected. In this case, when the group status of the other mobile devices detected as being located in the vicinity of that mobile device does not match the group status registered in the group registration unit due to misplacement by the user etc., the announcing unit is operated, and therefore, the user can quickly notice that he or she has misplaced a mobile device based on this announcement.

The communication unit may use wireless or wired communication. When using wireless communication, for example, a communication method such as Bluetooth, infrared communication, human-body communication, or near field communication (NFC) may be employed. When using wired communication, for example, a communication method using contact terminals may be employed.

In the mobile device described above, a communication range of the communication unit may be set to a range allowing the user to confirm that the mobile devices are being carried together.

According to this configuration, the other mobile devices identified by the identification information received by the communication unit can be assumed to be carried together with a particular mobile device by the user. The communication range may be, for example about 1 m to 10 m.

In the mobile device described above, the communication unit is, for example, a short-range communication unit.

With this configuration, since the short-range communication unit is used as the communication unit, the other mobile devices which are identified by the identification information received by the communication unit can be assumed to be carried together with a particular device by the user. An example of the short-range communication unit is a Bluetooth device or the like.

In the mobile device described above, the control unit may operate the announcing unit when a combination of the identification information of the detected other mobile devices differs from a combination of the identification information registered as a group in the group registration unit, or when a number of items of the identification information of the detected other mobile devices differs from a number of items of the identification information registered as a group in the group registration unit.

According to this configuration, when other mobile devices which were, until now, within the predetermined range go outside the predetermined range due to misplacement etc., the combination or number of other mobile devices detected as being located within the predetermined range of a mobile device does not match the combination or number of items of identification information registered as a group in the group registration unit. Therefore, by periodically monitoring the combination or number of items in the group, it is possible to readily detect misplacement of a mobile device.

In the mobile device described above, the control unit may send owner information of that device together with the identification information using the communication unit, and when the identification information and the owner information are received from the other mobile devices, the control unit may determine whether or not the received owner information matches the owner information of the mobile device, and when there is no match, may operate the announcing unit.

According to this configuration, when the owner information of the other mobile devices does not match the owner information of that device, that fact is reported by the announcing unit. Therefore, the user can quickly notice that he or she has taken someone else's mobile device based on this announcement.

In the mobile device described above, when operating the announcing unit, the mobile device may query whether the group registered in the group registration unit is to be updated.

According to this configuration, when notification of misplacement etc. of a mobile device is made by the announcing unit, the user is queried as to whether the group registered in the group registration unit is to be updated to the group of mobile devices being carried at that time. Therefore, the user can decide by himself whether to update the registration. Thus, when, for example, the user decides to change the mobile devices being carried, the combination of mobile devices after the change is registered as a new group in the group registration unit, and therefore, it is possible to remove the burden of performing announcing with the announcing unit again.

The various aspects described above can be used in combination within the permissible scope of the invention.

According to the mobile device system or mobile device described above, even when there is a change to the mobile devices being carried, the system can flexibly respond in those changes, which affords an advantage in that it is possible to prevent misplacement or the like of a mobile device.

Embodiments of a mobile device system will be described below with reference to the drawings.

### FIRST EMBODIMENT

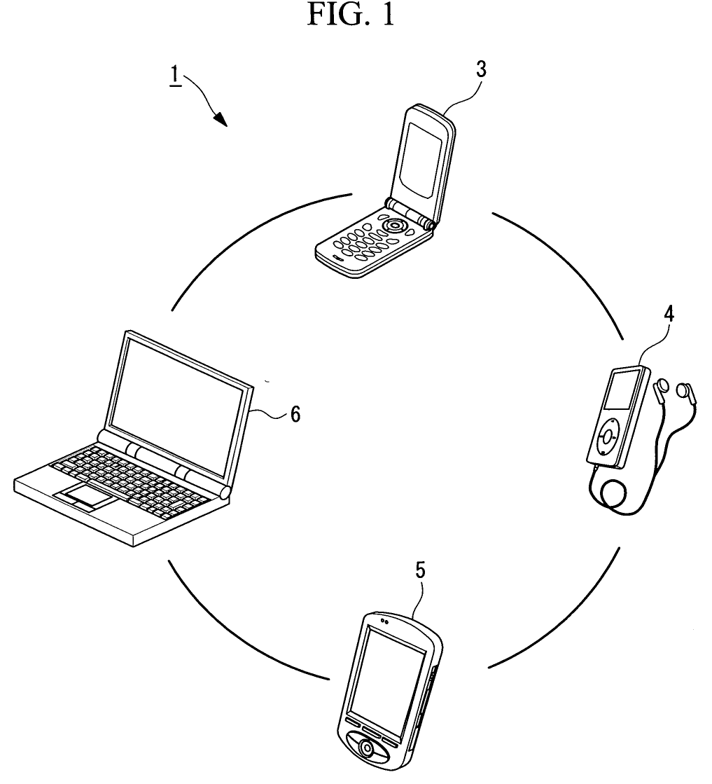

FIG. 1 illustrates an example configuration of a mobile device system 1 according to a first embodiment. As shown in the drawing, the mobile device system 1 includes a plurality of mobile devices or, more specifically, a mobile phone 3, a portable music player 4, a PDA (personal digital assistant) 5, and a laptop computer (hereinafter referred to as ‘computer’) 6. Unique identification information is assigned to each mobile device.

These mobile devices are only examples, and in general, any type of portable electronic device may be used in any combination. For instance, an example of a mobile device is a wearable personal computer that is embedded in clothes.

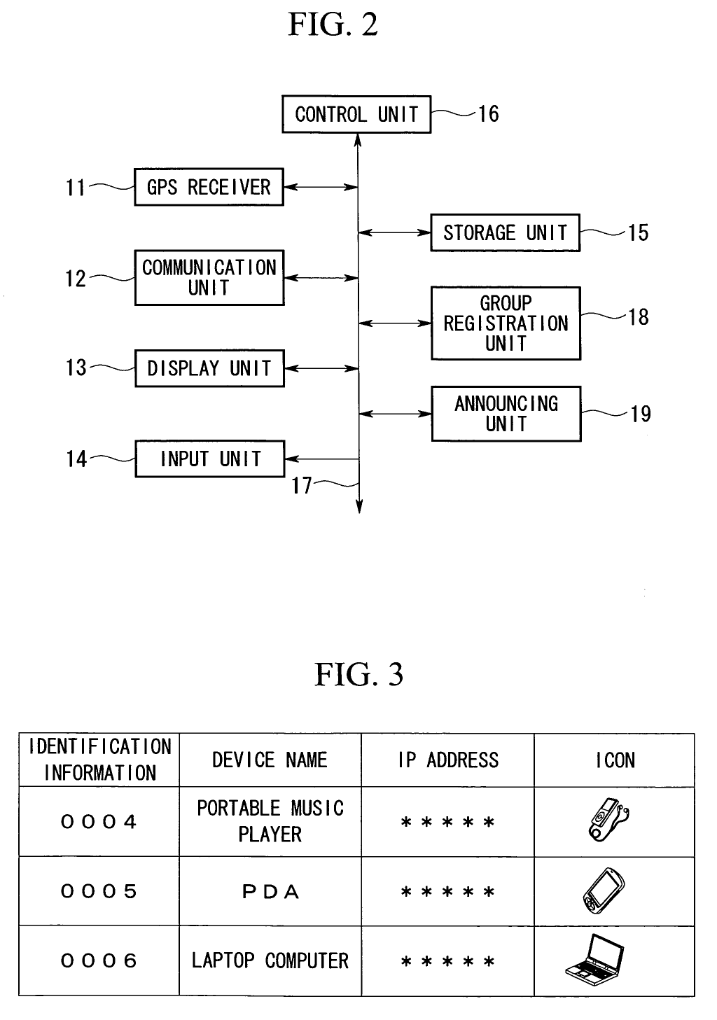

Each of the above-described mobile devices includes the following common components. Specifically, as illustrated in FIG. 2, each mobile device includes a GPS receiver (location-information acquiring device) 11, a communication unit (communication device) 12, a display unit 13, an input unit 14, a storage unit 15, a control unit (control device) 16, a group registration unit (group registration device) 18, and an announcing unit (announcing device) 19. These units are mutually connected via a bus 17 and are capable of sending and receiving information between each other.

The components may be provided separately from components that are generally included in each mobile device, or the components that are generally included in each mobile device may also serve as the above-described components. For example, since the mobile phone 3 generally includes a communication unit, a display unit, and an input unit, these units are preferably shared. This also applies to the other mobile devices.

The GPS receiver 11 periodically receives a signal from a GPS satellite, acquires location information of the mobile device in which it is installed on the basis of the received signal, and outputs the location information to the control unit 16. The communication unit 12 is capable of communicating with other mobile devices by wireless communication. For example, the communication unit 12 of the mobile phone 3 is capable of communicating with the portable music player 4, the PDA 5, and the computer 6.

The display unit 13 is, for example, a liquid crystal display. The input unit 14 is, for example, a keyboard or buttons and functions as a man-machine interface.

The storage unit 15 holds information about the other mobile devices. More specifically, the storage unit 15 holds identification information for each of the other mobile devices. Various kinds of information, including the name of the mobile device, information for enabling two-way communication, and image data to be displayed on the display unit 13, are linked to the identification information of each mobile device. The information for enabling two-way communication is, for example, an IP address of the device to be communicated with. The image data to be displayed on the display unit 13 is, for example, icons or text information. For example, as shown in FIG. 3, identification information of the portable music player 4, the PDA 5, and the computer 6 is stored in the storage unit 15 of the mobile phone 3. The device names, IP addresses, and image data to be displayed on the display unit 13 are linked to the identification information of the other mobile devices. The control unit 16 performs overall control of the above-described units.

Identification information of the other mobile devices within a predetermined range of the mobile device is registered in the group registration unit 18. When the combination of the other mobile devices within a predetermined range changes, the announcing unit 19 announces that fact. For example, a light-emitting diode (LED) that achieves this announcement by means of being illuminated, a speaker that provides an audible announcement, or a vibration motor that achieves this announcement by means of vibrations may be employed as the announcing unit 19.

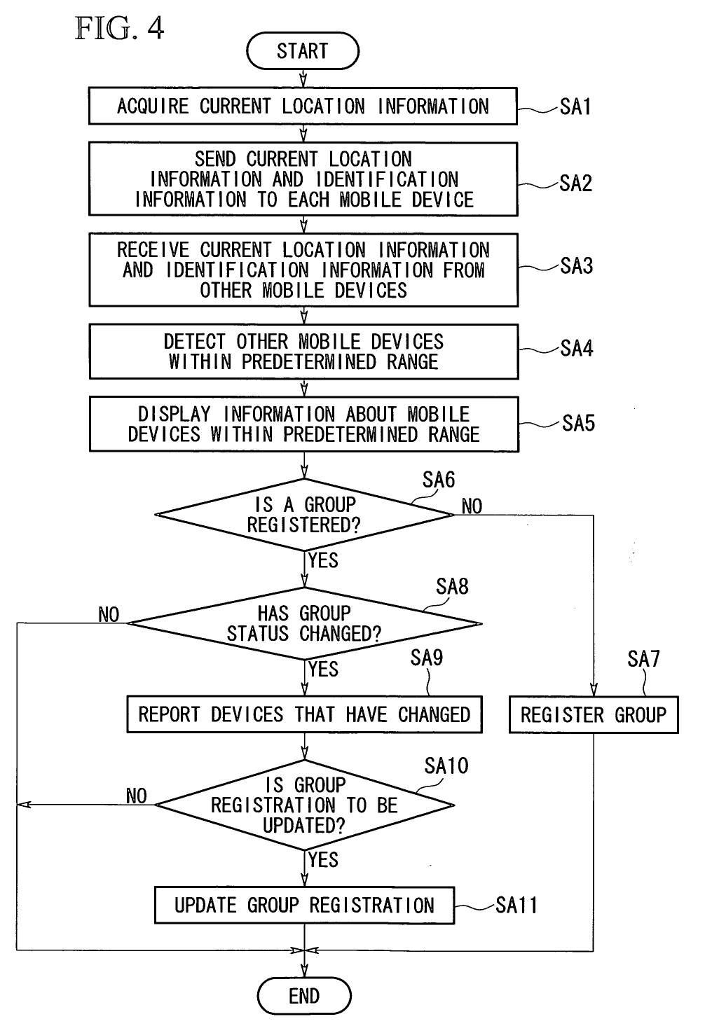

In the mobile devices having such common configurations, the control units 16 repeatedly execute a misplacement detection process, as shown in FIG. 4, at predetermined intervals. Although the process described below is executed in the control unit 16 of each mobile device, for simplification, the process executed by the control unit 16 of the mobile phone 3 will be described as a representative example.

First, when location information acquired by the GPS receiver 11 is input to the control unit 16 of the mobile phone 3 (Step SA1 of FIG. 4), information linking the location information to an identification number “0003” of the mobile phone 3 is sent to other mobile devices from the communication unit 12 (Step SA2). In this way, the current location information and the identification information of the mobile phone 3 are sent to the portable music player 4, the PDA 5, and the computer 6. On the other hand, by executing the same process in the control units 16 of the portable music player 4, the PDA 5, and the computer 6, the current location information is mutually sent and received between the mobile devices, and the communication unit 12 of the mobile phone 3 receives the identification information and the current location information of the portable music player 4, the PDA 5, and the computer 6 (Step SA3).

Subsequently, on the basis of the received current location information of the portable music player 4, the PDA 5, and the computer 6 and the current location information of the mobile phone 3, the control unit 16 determines whether or not the portable music player 4, the PDA 5, and the computer 6 are within a predetermined range of the mobile phone 3 to detect the mobile devices located within the predetermined range (Step SA4). Here, the predetermined range is a range for determining whether other mobile devices are carried together with a certain mobile device and can be set arbitrarily according to the design. For example, the range can be set between approximately 3 and 5 m.

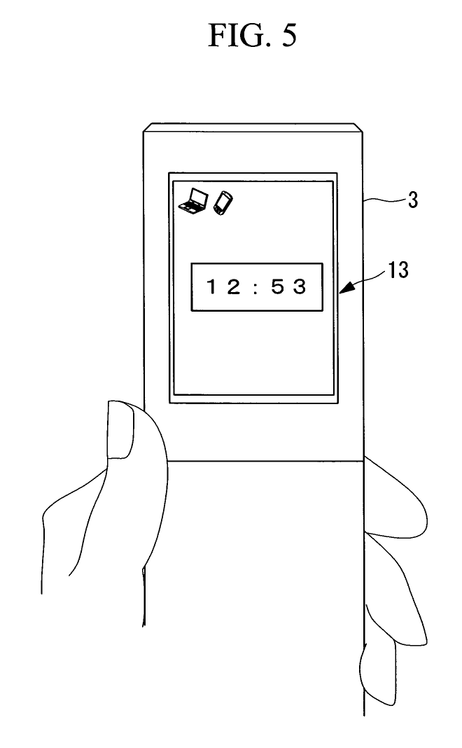

Then, the control unit 16 acquires icons linked to the identification information of the other mobile devices determined to be within the predetermined range from the storage unit 15 and displays the icons on the display unit 13 (Step SA5). In this way, the icons of the other mobile devices within the predetermined range of the mobile phone 3 are displayed on the display unit 13. For example, FIG. 5 illustrates an example display on the display unit 13 when the PDA 5 and the computer 6 are determined to be within the predetermined range.

Subsequently, the control unit 16 determines whether or not a group has been registered in the group registration unit 18. Since a group has not yet been registered, the process proceeds to Step SA7, where the identification information of the other mobile devices determined to be within the predetermined range in Step SA4 is registered in the group registration unit 18. For example, if the PDA 5 and the computer 6 are determined to be within the predetermined range of the mobile phone 3 in Step SA4, the identification number “0005” of the PDA 5 and the identification number “0006” of the computer 6 are registered as a group by the group registration unit 18 of the mobile phone 3, and the process then ends.

Next, after a predetermined amount of time, the control unit 16 executes the process shown in FIG. 4 again.

In this way, as described above, other mobile devices within the predetermined range of the mobile phone 3 are detected, and information about these mobile devices is displayed on the display unit 13 (Steps SA1 to SA5). Then, in Step SA6, the control unit 16 determines whether or not a group has been registered in the group registration unit 18. Since a group is already registered, the process proceeds to Step SA8 so as to determine whether there is a change in the group status. More specifically, the control unit 16 determines whether or not the combination of mobile devices determined to be within the predetermined range of the mobile phone 3 through the above-described process matches the combination of mobile devices registered in the group registration unit 18. As a result, for example, if the PDA 5 and the computer 6 are determined to be within the predetermined range through this process, in other words, if the other mobile devices that are registered are within the predetermined range of the mobile phone 3 in this process, it is determined in Step SA8 that there is no change in the group status, and then the process ends.

When there is a change in the combination of mobile devices determined to be within the predetermined range of the mobile phone 3 and when the combination of mobile devices detected in Step SA4 differs from the combination of mobile devices registered as a group, the control unit 16 operates the announcing unit 19 to announce this fact (Step SA9). In this way, the user is notified of when the number of mobile devices he or she is carrying together changes; as a result, the user can quickly notice that he or she has misplaced a mobile device. In such a case, since the mobile devices currently being carried are displayed on the display unit 13, the user can view the display and determine which mobile device he or she has misplaced.

Subsequently, the control unit 16 queries the user as to whether or not to update the registered group (Step SA10). This inquiry is carried out by, for example, displaying a message “Update group registration?” on the display unit 13 or by providing an audio message. As a result, if there is an input for updating the registered group, the mobile devices detected in Step SA4 of the process are registered as a group in the group registration unit 18 (Step SA11), and then the process ends. If there is an input for not updating the registered group in Step SA10, the control unit 16 does not update the registered group, and then the process ends.

Here, for example, when the user decides to increase the number of mobile devices he or she is carrying or when the user leaves a mobile device behind, then, misplacement of a mobile device must be determined on the basis of the new combination of mobile devices. If the registered group were not updated, the same notification would be provided the next time the process is executed, and the user would be bothered by this notification. Thus, as described above, convenience can be enhanced by allowing the user to determine whether or not to update the registered group.

Then, the control unit 16 repeatedly executes the misplacement detection process shown in FIG. 4 at predetermined intervals to periodically detect misplacement of a mobile device and notifies the result to the user.

As described above, in this mobile device system 1, other mobile devices that are determined to be within the predetermined range of a particular mobile device are registered as a group. Thus, even when the user carries a different combination of mobile devices on different days, the system can flexibly respond in those situations and can register, as a group, information about the mobile devices carried together.

When the mobile devices registered as a group are detected not to be within the range of the mobile device, that fact is notified to the user, and therefore, it is possible to quickly detect when misplacement of a device occurs and to notify the user quickly.

In this embodiment, it is determined whether or not there is a change in the group status based on whether or not the combination of identification information registered in the group registration unit 18 in step SA8 in FIG. 4 matches the combination of identification information of the mobile devices detected in step SA4. Instead of this, however, a change in the group status may be determined based on whether or not the number of items of identification information registered in the group registration unit 18 matches the number of items of identification information of the mobile devices detected in step SA4. With this configuration, it is possible to reduce the amount of processing required.

In the embodiment described above, the group registration performed by the group registration unit 18 may be performed when, for example, a registration request button for instructing a registration request is provided on each mobile device and the registration request button of any mobile device is operated by the user.

In addition, a registration cancellation area in which a group registered in the group registration unit 18 is cancelled may be set up in advance and the group registration may be cancelled when the user is in this registration cancellation area. Also, when the user leaves this registration cancellation area, by automatically executing the misplacement detection process shown in FIG. 4 in the control unit 16, new group registration may be performed. In this case, it is preferable, for example to set up a registration cancellation area at one's home. By setting it up in this way, the misplacement detection process shown in FIG. 4 is automatically started when the user leaves home, and the mobile devices that he or she takes outside are registered as a group in the group registration unit 18. Thus, even if the combination of mobile devices taken from home changes from day to day, it is possible to perform group registration of the mobile devices at a suitable timing according to this change. The determination of whether or not the user is in the registration cancellation area can be performed, for example, by registering location information of the registration cancellation area in advance, and determining whether or not location information received by the GPS receiver 11 is inside the registration cancellation area.

In this embodiment, each mobile device may link and save identification information about that device and identification information about its owner. In this case, the identification information about the owner is sent together with the current location information of that device to other mobile devices. By doing so, not only the current location information but also the owner identification information is exchanged between mobile devices. Then, each mobile device determines whether or not the owner identification information of that device matches the owner information of the other mobile devices, which is received by the communication unit 12, and if there is no match, that fact is reported to the user by operating the announcing unit 19.

When carrying mobile devices with different owner identification information, that fact is reported by the announcing unit 19. Therefore, the user can quickly see that he or she has mistakenly picked up someone else's mobile device. A plurality of items of owner identification information may be registered in a single mobile device, and any of the plurality of items of registered owner identification information should match. This configuration can be applied in situations where a single mobile device is shared by multiple users.

### SECOND EMBODIMENT

Next, a mobile device system according to a second embodiment will be described.

The mobile device system includes, for example, a mobile phone 3, a portable music player 4, a PDA 5, and a computer 6, like the first embodiment described above. A description of parts of the mobile device system that are the same as those used in the first embodiment will be omitted here, and only the parts that differ will be described.

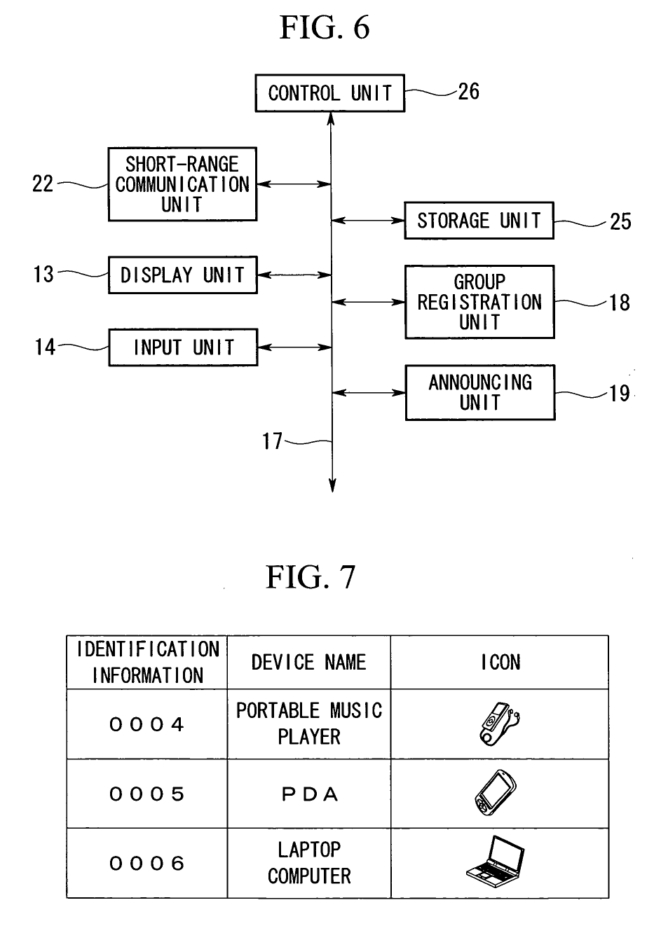

Each mobile device constituting the mobile device system includes common components such as those shown in FIG. 6. Specifically, each mobile device includes a short-range communication unit (communication device) 22, a display unit 13, an input unit 14, a storage unit 25, a control unit (control device) 26, a group registration unit (group registration device) 18, and an announcing unit (announcing device) 19. These components are connected to each other via a bus 17 and are configured so as to be capable of sending and receiving information between each other.

The short-range communication unit 22 can communicate with other mobile devices located in the vicinity. The communication range of this short-range communication unit 22 is preferably a range that allows communication between mobile devices that are carried at the same time, for example, a range of about 1 m to 10 m. A known short-range communication device using, for example, wired or wireless communication can be employed as the short-range communication unit 22. When using wireless communication, for example, a communication method such as Bluetooth, infrared communication, human-body communication, or near field communication (NFC) may be employed. When using wired communication, for example, a communication method using contact terminals may be employed.

Information about the other mobile devices is stored in the storage unit 25. More specifically, identification information of each of the other mobile devices is stored, and various types of information, such as a name or image data to be displayed on the display unit 13, is linked to each item of identification information. Examples of the image data or the like to be displayed on the display unit 13 include icons or text information. For instance, as shown in FIG. 7, identification information of the portable music player 4, the PDA 5, and the computer 6 is stored in the storage unit 25 of the mobile phone 3, and a name, image data or the like to be displayed on the display unit 13 is linked to each item of identification information and is stored. The control unit 26 performs overall control of each of the components described above.

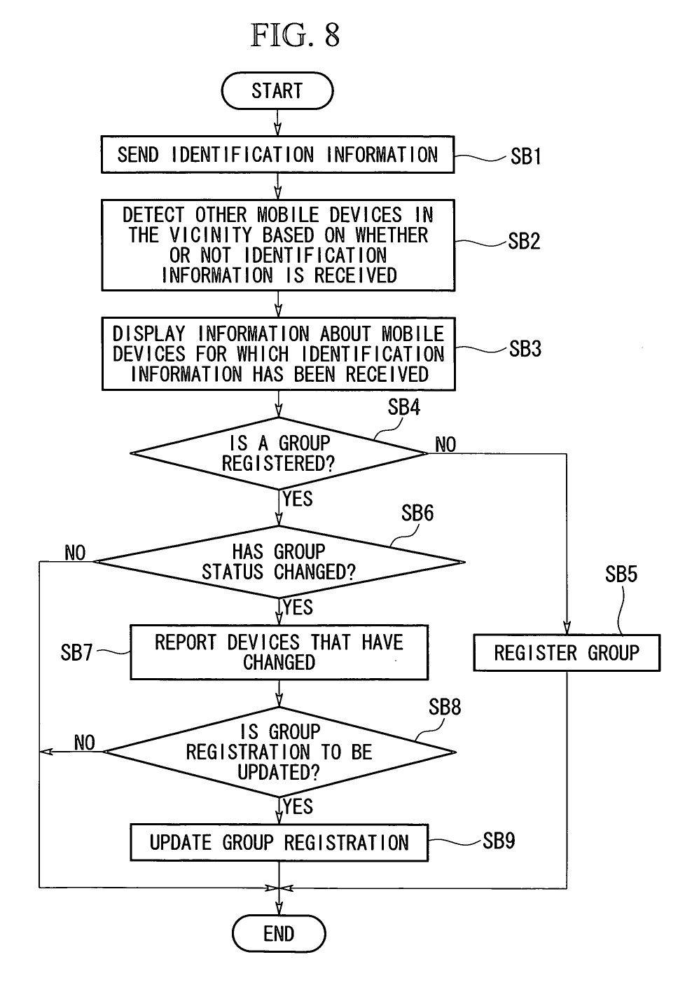

In each mobile device having such a common configuration, the misplacement detection process shown in FIG. 8 is repeatedly executed by the control unit 26 at fixed intervals. The misplacement detection process according to this embodiment is described below with reference to FIG. 8. The misplacement detection process shown below is executed by the control unit 26 in each mobile device, but for the sake of convenience, the processing in the control unit 26 of the mobile device 3 will be described here as a representative example.

First, the control unit 26 of the mobile phone 3 sends identification information “0003” assigned to the mobile phone 3 using the short-range communication unit 22 (step SB1). Accordingly, the identification information “0003” of the mobile phone 3 is received by other mobile devices located within the communication range of the short-range communication unit 22 of the mobile phone 3. On the other hand, by executing the same process in the control units 26 of the portable music player 4, the PDA 5, and the computer 6, their identification information is mutually exchanged with the mobile devices located within the communication range of their short-range communication units 22.

Then, the control unit 26 detects other mobile devices located in the vicinity based on whether or not it could receive the identification information of other mobile devices (step SB2), obtains icons for the other detected mobile devices from the storage unit 25, and displays them on the display unit 13 (step SB3). Accordingly, the icons for the other mobile devices that are located in the vicinity of the mobile phone 3 are displayed on the display unit 13. Thus, the user can check which mobile devices he or she is carrying together by looking at the display unit 13 of any of the mobile devices.

Next, the control unit 26 determines whether or not a group is registered in the group registration unit 18 (step SB4). As a result, since a group is not yet registered, the process proceeds to step SB5, where the identification information of the other mobile devices detected as being located in the vicinity in step SB2 is registered in the group registration unit 18, and the process then ends. For example, when the identification information of the PDA 5 and the identification information of the computer 6 are received in step SB2, the identification information “0005” of the PDA 5 and the identification information “0006” of the computer 6 are registered as a group by the group registration unit 18 of the mobile phone 3, and the process then ends.

Next, after a predetermined period of time, the control unit 26 executes the processing shown in FIG. 8 again.

By doing so, as described above, the other mobile devices located in the vicinity of the mobile phone 3 are detected, and information thereof is displayed on the display unit 13 (steps SB1 to SB3). Then, in step SB4, the control unit 26 determines whether a group is registered in the group registration unit 18. As a result, since a group has already been registered, the process proceeds to step SB6, where it is determined whether the group status has changed. More specifically, it is determined whether the combination of mobile devices detected as being located in the vicinity of the mobile phone 3 in this processing matches the combination of mobile devices registered in the group registration unit 18. If, as a result, the PDA 5 and the computer 6 are detected as being located in the vicinity in this processing, there is no change in the group status in step SB6, and the process ends.

In contrast, if there is a change in the combination of mobile devices detected as being located in the vicinity of the mobile phone 3, that is, if the combination of mobile devices detected in step SB2 differs from the combination of mobile devices registered as a group, the control unit 26 announces that fact by operating the announcing unit 19 (step SB7). Accordingly, because the user is informed that the number of mobile devices which he or she is carrying together has changed, the user can quickly notice that he or she has misplaced a mobile device. In such a case, because the mobile devices currently being carried are displayed on the display unit 13, the user can see which mobile device he or she has misplaced by looking at the display.

Next, the control unit 26 queries the user as to whether or not the group registration is to be updated (step SB8). This is achieved by, for example, displaying a message such as “Update group registration?” on the display unit 13 or by issuing an audio message. If, as a result, there is an input indicating that the group registration is to be updated, the mobile devices detected in step SB2 of this process are registered as a group in the group registration unit 18 (step SB9), and the process then ends. On the other hand, if there is an input indicating that group registration is not to be updated in step SB8, the control unit 26 ends the process without updating the group registration.

Then, by repeatedly executing the misplacement detection process shown in FIG. 8, the control unit 26 periodically determines whether a mobile device has been misplaced and reports the result to the user.

As described above, according to the mobile device system, the other mobile devices located within the communication range of the short-range communication unit 22, in other words, in the vicinity, are registered as a group. Therefore, even if the combination of mobile devices that the user carries changes from day to day, the system can flexibly respond in those situations and can register, as a group, the information about the mobile devices being carried together.

Also, when the combination of identification information of the other mobile devices detected as being located in the vicinity of a certain mobile device differs from the combination of identification information of the other mobile devices registered as a group, that fact is reported to the user. Therefore, if the user misplaces a device, that fact can be detected quickly and the user can be notified.

In this embodiment, in step SB6 in FIG. 8, it is determined whether or not the group status has changed on the basis of whether or not the combination of identification information registered in the group registration unit 18 matches the combination of identification information of the mobile devices detected in step SB2. Instead of this, however, it may be determined whether or not the group status has changed on the basis of whether or not the number of items of identification information registered in the group registration unit 18 matches the number of items of identification information of the mobile devices detected in step SB2. Furthermore, if identification information registered in the group registration unit 18 cannot be received, an announcement may be made by the announcing unit 19. By doing so, it is possible to reduce the amount of processing.

Embodiments of a mobile device system and a mobile device have been described above with reference to the drawings, but the specific configurations are not limited to these embodiments. The present invention encompasses various modifications so long as they do not depart from the spirit of the invention.

What is claimed is:

1. A mobile device system comprising:
a plurality of mobile devices, to each of which unique identification information is assigned;
wherein each mobile device includes
a communication unit configured to communicate with other mobile devices,
a location-information acquisition unit configured to acquire current location information of that mobile device,
a group registration unit,
an announcing unit, and
a control unit;
wherein, in each mobile device, the control unit
links the location information acquired by the location-information acquisition unit with the identification information of that mobile device, sends the information to the other mobile devices using the communication unit, detects the other mobile devices located within a predetermined range of the mobile device on the basis of location information received from the other mobile devices by the communication unit and the location information of the mobile device, and registers the identification information of the detected other mobile devices as a group in the group registration unit, and
after registering the group, by periodically operating the communication unit, periodically detects the other mobile devices located within the predetermined range of the mobile device and operates the announcing unit when a group status of the detected other mobile devices differs from a group status registered in the group registration unit.

2. A mobile device system comprising:
a plurality of mobile devices, to each of which unique identification information is assigned;
wherein each mobile device includes
a communication unit configured to communicate with other mobile devices located in the vicinity,
a group registration unit,
an announcing unit, and
a control unit;
wherein, in each mobile device, the control unit
sends the identification information assigned to that mobile device using the communication unit, detects other mobile devices located in the vicinity of that mobile device on the basis of whether or not the identification information is received from the other mobile devices by the communication unit, and registers the identification information of the detected other mobile devices as a group in the group registration unit, and
after registering the group, by periodically operating the communication unit, periodically detects the other mobile devices located in the vicinity of the mobile device and operates the announcing unit when a group status of the detected other mobile devices differs from a group status registered in the group registration unit.

3. A mobile device system according to claim 2, wherein a communication range of the communication unit is set to a range allowing the user to confirm that the mobile devices are being carried together.

4. A mobile device system according to claim 2 wherein the communication unit is a short-range communication unit.

5. A mobile device system according to claim 1, wherein the control unit in each mobile device operates the announcing unit when a combination of the identification information of the detected other mobile devices differs from a combination of the identification information registered as a group in the group registration unit, or when a number of items of the identification information of the detected other mobile devices differs from a number of items of the identification information registered as a group in the group registration unit.

6. A mobile device system according to claim 2, wherein the control unit in each mobile device operates the announcing unit when a combination of the identification information of the detected other mobile devices differs from a combination of the identification information registered as a group in the group registration unit, or when a number of items of the identification information of the detected other mobile devices differs from a number of items of the identification information registered as a group in the group registration unit.

7. A mobile device system according to claim 1, wherein:
owner information is assigned to each mobile device, and
the control unit in each mobile device links the identification information of that mobile device with the owner information of that mobile device and sends the information using the communication unit, and when the identification information and the owner information are received from the other mobile devices by the communication unit, the control unit determines whether or not the received owner information matches the owner information of the mobile device and, when there is no match, operates the announcing unit.

8. A mobile device system according to claim 2, wherein:
owner information is assigned to each mobile device, and
the control unit in each mobile device links the identification information of that mobile device with the owner information of that mobile device and sends the information using the communication unit, and when the identification information and the owner information are received from the other mobile devices by the communication unit, the control unit determines whether or not the received owner information matches the owner information of the mobile device and, when there is no match, operates the announcing unit.

9. A mobile device system according to claim 1, wherein when operating the announcing unit, each mobile device queries whether the group registered in the group registration unit is to be updated.

10. A mobile device system according to claim 2, wherein when operating the announcing unit, each mobile device queries whether the group registered in the group registration unit is to be updated.

11. A mobile device comprising:
a communication unit configured to communicate with other mobile devices;
a location-information acquisition unit configured to acquire current location information of that mobile device;
a group registration unit;
an announcing unit; and
a control unit,
wherein the control unit
links the location information acquired by the location-information acquisition unit with the identification information of that mobile device, sends the information to the other mobile devices using the communication unit, detects the other mobile devices located within a predetermined range of the mobile device on the basis of the location information received from the other mobile devices by the communication unit and the location information of the mobile device, and registers the identification information of the detected other mobile devices as a group in the group registration unit, and
after registering the group, by periodically operating the communication unit, periodically detects the other mobile devices located within the predetermined range of the mobile device and operates the announcing unit when a group status of the detected other mobile devices differs from a group status registered in the group registration unit.

12. A mobile device comprising:
a communication unit configured to communicate with other mobile devices located in the vicinity thereof;
a group registration unit;
an announcing unit; and
a control unit,
wherein the control unit
sends identification information assigned to that mobile device using the communication unit, detects other mobile devices located in the vicinity of that mobile device on the basis of whether or not the identification information is received from the other mobile devices by the communication unit, and registers the identification information of the detected other mobile devices as a group in the group registration unit, and
after registering the group, by periodically operating the communication unit, periodically detects the other mobile devices located in the vicinity of the mobile device and operates the announcing unit when a group status of the detected other mobile devices differs from a group status registered in the group registration unit.

13. A mobile device according to claim 12, wherein a communication range of the communication unit is set to a range allowing the user to confirm that the mobile devices are being carried together.

14. A mobile device according to claim 12, wherein the communication unit is a short-range communication unit.

15. A mobile device according to claim 11, wherein the control unit operates the announcing unit when a combination of the identification information of the detected other mobile devices differs from a combination of the identification information registered as a group in the group registration unit, or when a number of items of the identification information of the detected other mobile devices differs from a number of items of the identification information registered as a group in the group registration unit.

16. A mobile device according to claim 12, wherein the control unit operates the announcing unit when a combination of the identification information of the detected other mobile devices differs from a combination of the identification information registered as a group in the group registration unit, or when a number of items of the identification information of the detected other mobile devices differs from a number of items of the identification information registered as a group in the group registration unit.

17. A mobile device according to claim 11, wherein the control unit sends owner information of that device together with the identification information using the communication unit, and when the identification information and the owner information are received from the other mobile devices, the control unit determines whether or not the received owner information matches the owner information of the mobile device, and when there is no match, operates the announcing unit.

18. A mobile device according to claim 12, wherein the control unit sends owner information of that device together with the identification information using the communication unit, and when the identification information and the owner information are received from the other mobile devices, the control unit determines whether or not the received owner information matches the owner information of the mobile device, and when there is no match, operates the announcing unit.

19. A mobile device according to claim 11, wherein when operating the announcing unit, the mobile device queries whether the group registered in the group registration unit is to be updated.

20. A mobile device according to claim 12, wherein when operating the announcing unit, the mobile device queries whether the group registered in the group registration unit is to be updated.
